(19) United States
(12) Patent Application Publication
(10) Pub. No.: US 2020/0224072 A1
(43) Pub. Date: Jul. 16, 2020

(54) METHOD FOR THERMO-CHEMICAL ENERGY STORAGE

(71) Applicants: Technische Universitaet Wien, Vienna (AT); Akademie Der Bildenden Kuenste Wien, Vienna (AT)

(72) Inventors: Danny MUELLER, Wein (AT); Christian KNOLL, Wien (AT); Peter WEINBERGER, Altenberg (AT); Andreeas WERNER, Stockerau (AT); Michael HARASEK, Wien (AT)

(73) Assignees: Technische Universitaet Wien, Vienna (AT); Akademie Der Bildenden Kuenste Wien, Vienna (AT)

(21) Appl. No.: 16/641,413

(22) PCT Filed: Aug. 14, 2018
(86) PCT No.: PCT/EP2018/072067

§ 371 Date: Feb. 24, 2020

(30) Foreign Application Priority Data
Aug. 29, 2017 (AT) 3452017

(51) Int. Cl. C09K 5/16; F28D 20/00

(52) U.S. Cl. CPC C09K 5/16; F28D 20/003

(57) ABSTRACT

The invention relates to a method of thermo-chemical energy storage by carrying out reversible chemical reactions for storing heat energy in the form of chemical energy in one or more ammine complexes of transition metal salts of the formula [Me(NH₃)ₙ]X, wherein Me is at least one transition metal ion and X is one or more counterions in an amount sufficient for charge equalization of the complex, by using the following chemical equilibrium:

[Me(NH₃)ₙ]X+ΔH_{R} [symbol] MeX+nNH₃,

characterized in that said heat storage is performed by endothermic cleavage of the NH₃ ligands from the ammine complex and/or that the heat release is performed by exothermic loading of the transition metal salt with the NH₃ ligands in at least two steps at different temperatures.

The present invention relates to a method of thermo-chemical energy storage by executing reversible chemical reactions in order to store heat energy in the form of chemical energy.

### PRIOR ART

Thermochemical energy storage, i.e. the storage of thermal energy in the form of chemical energy, is a method of energy storage comprising cyclization of at least one chemical compound between the statuses of at least one reversible equilibrium reaction, which has been known for decades, but has only been intensively researched for a few years. U.S. Pat. No. 4,365,475, for example, reveals the combination of two equilibrium reactions for the purpose of thermochemical energy storage, namely the alternating reversible endothermic formation of the ammine complexes CaCl₂.8NH₃ and ZnCl₂.NH₃.

Among other complexes of alkaline earth and transition metals, combinations are known as systems specifically using ammine complexes, in which the ammine complexes alternate between two different coordination states. Examples are a combination of the two chlorides CaCl₂ and FeCl₂, with which the following reactions are carried out according to U.S. Pat. No. 4,319,627:

CaCl₂.8NH₃ [symbol] CaCl₃+4NH₃

FeCl₂.2NH₃+4NH₃ [symbol] FeCl₂,6NH'

or another combination of calcium chloride, namely CaCl₂ and MnCl₂, which according to Li et al., AlChE J. 59(4), 1334-1347 (Apr. 2013), undergo the following reactions in a similar way to the above combination with iron chloride:

CaCl₂.8NH₃ [symbol] CaCl₂.4NH₃+4NH₃

MnCl₂.2NH₃+4NH₃ [symbol] MnCl₂.6NH₃

As a further example of ammine complexes of a transition metal chloride, Aidoun and Ternan, Appl. Therm. Eng. 21, 1019-1034 (2001), disclose the use of cobalt chloride according to the following equation:

CoCl₂.2NH₃+4NH₃ [symbol] CoCl₂.6NH₃

However, the energy storage density of the above-mentioned systems is rather low in most known cases, and the corrosiveness of some of the salts used often poses a device-related problem. Additionally, also the transport and storage of the metal salts used will cause issues, since the temperatures reached during the exothermic reaction are often close to or even higher than the melting points of these salts or complexes, respectively, so that at least some of the salts will melt, thus leading to agglomeration.

The present inventors proposed a solution to this problem in their pending Austrian Patent Application AT A 327/2016, which discloses a process in which ammine complexes of transition metal salts are formed and decomposed according to the following reversible sum reactions:

[Me(NH₃)ₙ]X+ΔH_{R} [symbol] MeX+nNH₃

or in alternative notation:

MeX.nNH₃+ΔH_{R} [symbol] MeX+nNH₃,

wherein Me represents at least one transition metal ion and X represents one or more counterions in an amount sufficient to neutralize the complex, according to their valences and that of the transition metal ion, wherein one or more transition metal salts are used supported on a carrier material which is inert to the reaction.

In contrast to the systems cited at the beginning, this only involves the ammine complex formation reaction of the at least one transition metal salt instead of a combination of two parallel reactions complementing each other chemically or thermodynamically. This means that there is no switching back and forth between the different coordination numbers of the ammine complexes, but rather the entire enthalpy of formation of the ammine complexes is recovered during the exothermic reaction. The inventors have discovered that transition metal ammine complexes have very high enthalpies of formation. This could lead to the problems mentioned above in connection with the at least partial melting of salts or complexes. However, the invention solves this problem by depositing the metal salts onto a carrier, thus achieving a “dilution” of the salts at the same time, so that melting processes and the associated agglomeration of the salts are precluded. The transition metal salts supported on the carrier remain easy to handle even at higher temperatures. If a particulate carrier is used, the material remains free-flowing and can therefore be easily transported and stored.

The disadvantage of this procedure is that, as mentioned above, especially without the use of a carrier material, but sometimes also despite its use, excessive heat development can occur, which causes at least partial melting of the transition metal salt, which can lead to the formation of aggregates or lumps or to blockage of the pores of a large heat storage medium during cooling.

The objective of the invention was therefore the development of an alternative process to solve these problems.

### DISCLOSURE OF THE INVENTION

The present invention achieves this objective by providing a method of thermochemical energy storage by carrying out reversible chemical reactions for storing heat energy in the form of chemical energy in one or more ammine complexes of transition metal salts of the formula [Me(NH₃)ₙ]X, wherein Me is at least one transition metal ion and X is one or more counterions in an amount sufficient for charge equalization of the complex, using the following chemical equilibrium:

[Me(NH₃)ₙ]X+ΔH_{R} [symbol] MeX+nNH₃,

which, in comparison with the above procedure, is characterized by the fact that said heat storage is performed by endothermic cleavage of the NH₃ ligands from the ammine complex and/or that the heat release is performed by exothermic loading of the transition metal salt with the NH₃ ligands in at least two steps at different temperatures.

In the course of further research, the inventors have found that, in the ammine complexes of some transition metal salts, it is possible to cleave off the NH₃ ligands from the central atom, or to link them to it, individually or in pairs at different temperature levels and thus to achieve a ligand-free transition metal salt in at least two steps “cascading” from the fully coordinated ammine complex to the ligand-free transition metal salt or vice versa.

This allows for a more finely tuned adaptation of the process to the respective conditions, i.e. to a current excess or requirement of heat, by targeted loading of the heat storage medium with discrete amounts of heat, while simultaneously separating a respective part of the NH₃ ligands of the ammine complex, or the release of only a part of the heat stored in the heat storage medium by linking only a part of the maximum coordinateable ligands to the central atom at different respective temperatures.

For example, the tetrammine complex of CuSO₄ releases its four NH₃ ligands at temperatures starting at about 80° C. (1 ligand), about 170° C. (2 ligands) and about 310° C. (1 ligand), respectively, as will be shown in the following examples. In the event that there is not enough storable thermal energy (such as waste heat) available to heat the heat storage medium to over 300° C., it only needs to be heated to a temperature of >80° C. or >170° C. in a first step, whereby only one ligand or three ligands is/are cleaved off, respectively, and the amount of heat required to achieve this is stored in the form of chemical energy in the heat storage medium. The remaining ligand(s) can then be cleaved off at a later point in time when sufficient storable heat is available. In doing so, the coordination sites of the heat storage medium can also be replenished with NH₃ ligands in the meantime by releasing heat before the ligands are cleaved off again.

The reverse option is at least as important. For example, the heat stored in the ligand-free CuSO₄ is released with simultaneous stepwise regeneration of the tetrammine complex by contact with an ammonia-containing gas mixture at the following temperature levels: about 250° C. (1 ligand), about 140° C. (2 ligands) and just under 70° C. (1 ligand). If only a part of the stored heat is required, only a part of the coordination sites of the heat storage medium needs to be filled with ligands by directed cooling the hot CuSO₄ down to one of the two higher temperatures, and the rest of the stored heat can be released at a later point in time by completely filling all coordination sites with NH₃.

In the process of the present invention, a transition metal salt is preferably used, with which both the loading with heat and its re-release can be carried out stepwise, which applies particularly to the CuSO₄ mentioned.

In general, however, a salt of Cu, Ni, Co or Zn is preferably used as the transition metal salt, since the suitability of these metals for the process according to the invention has already been confirmed, which of course does not rule out the possibility that the inventors' current ongoing research will yield further suitable metals. A salt of Cu or Ni, especially Cu, is used even more preferentially, since their temperature levels can be controlled more precisely than those of the other preferred metals.

Furthermore, a sulfate or chloride, or even more preferably a sulfate, of the transition metal is preferably used in the process according to the invention, since the suitability of these anions has already been confirmed, whereas no ammine complex formation at all could be observed for the anions carbonate, silicate and phosphate in the inventor's first experiments. Due to the volatility of the chloride during the thermal decomposition of the complexes, sulfate is particularly preferred, especially CuSO₄, as was already mentioned above.

In further preferred embodiments of the invention, the transition metal salt is used supported on a storage material which is inert to the reaction, thus further reducing the risk of agglomeration of the heat storage medium and improving its handling. In addition, however, the temperature levels at which the NH₃ ligands are cleaved off from the respective ammine complex of the transition metal salt sometimes shift considerably. Without wanting to be bound to any specific theory, the inventors assume that the degree of this shift will depend on the specific heat capacity of the carrier material.

The inventors have found that not every carrier material is suitable for the cascading implementation of the process according to the invention, which is why the carrier material is preferably selected from silica, sepiolite, Celite, vermiculite and activated carbons, of which silica, sepiolite or Celite, in particular sepiolite, are used even more preferably, since by using these preferred carrier materials the temperature levels of the heat storage or heat release, respectively, can be controlled better compared to other cases, and particularly with sepiolite, it was found that it is not only particularly suitable for the process of the invention, but that it was also decisively more cost-effective when obtained commercially as compared to silica or Celite, for example.

When using a carrier material, the transition metal salt is preferably used thereon at a weight ratio between salt and carrier material of at least 1:1, or even more preferably at least 3:1, in order to enable a high amount of heat to be storable per weight unit of the combination. Even more preferably, the transition metal salt on the carrier material is used in a weight ratio between salt and carrier material of between 4:1 and 6:1, in particular in a weight ratio of about 5:1. If the amount of transition metal salt is to be kept as low as possible while at the same time retaining a high amount of storable heat, a ratio of only 1:1 can be selected.

### BRIEF DESCRIPTION OF THE DRAWINGS

The invention will be described in more detail below on the basis of concrete exemplary embodiments with reference to the enclosed drawings, the latter of which show the following.

FIGS. 1 to 7 show the results of thermogravimetric analyses of the ammine complexes from examples 1 to 5 according to the invention.

FIGS. 8, 10, 12, 17 and 18 show comparisons of the energy content stored in CuSO₄ on different carrier materials and in varying weight ratios as bar graphs.

FIGS. 9, 11 and 13 to 16 show the results of thermogravimetric analyses of the ammine complexes of examples 6 to 10 according to the invention and of comparison example 1, respectively.

### EXAMPLES

All reagents used in the following examples, i.e. transition metal salts and carrier materials, are commercially available and have been used without further purification.

### Synthesis Examples 1 to 5

Preparation of the Ammine Complexes

MeX+nNH₃ [symbol] [Me(NH₃)ₙ]X+ΔH_{R}

Me=Cu²⁺, Ni²⁺, Co²⁺, Zn²⁺
X=SOₓ²⁻ or 2Cl⁻
n=4 (for SO₄²⁻) or 5 (for Cl⁻), respectively

The respective anhydrous transition metal salt from commercial sources was converted to the ammine complexes in a laboratory fluidized bed reactor using an excess of NH₃.

In this way the following ammine complexes were produced:

Synthesis Example 1: [Cu(NH₃)₄]SO₄

Synthesis Example 2: [Ni(NH₃)₄]SO₄

Synthesis Example 3: [Co(NH₃)₄]SO₄

Synthesis Example 4: [Zn(NH₃)₄]SO₄

Synthesis Example 5: [Cu(NH₃)₅]Cl₂

### Examples 1 to 5—Tests Using Pure Transition Metal Salts

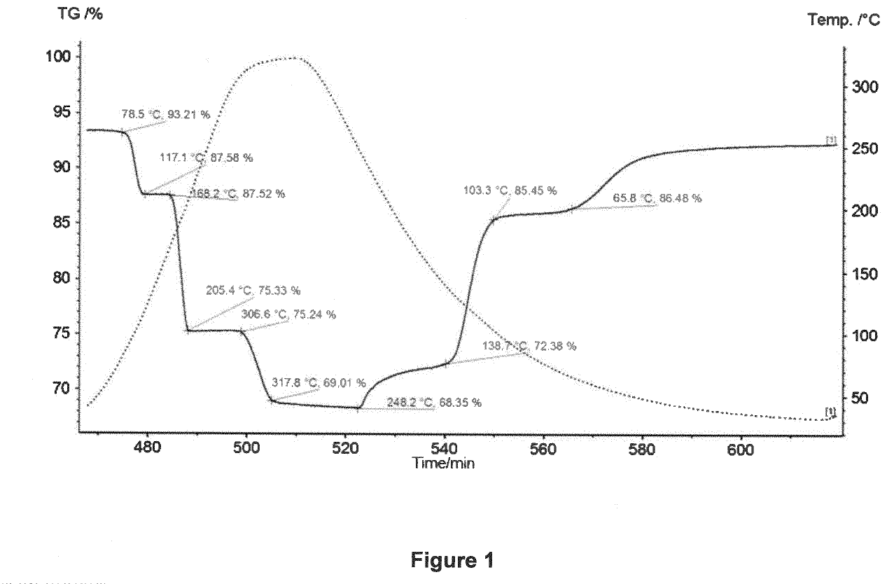

The ammine complexes prepared above were then heated in an Al₂ O₃ jar using a STA 449 C Jupiter® DSC TGA instrument from Netzsch under an atmosphere of N₂ at a heating rate of 10 K/min and cooled in N₂ atmosphere and thermo-gravimetrically analyzed. The introduction of ammonia was started immediately after reaching the maximum temperature. The TGA curves (uncorrected) plotted in this case are shown in FIGS. 1 to 7, where the continuous line indicates the weight and the dotted line indicates the temperature over time. The starting points (temperature as well as weight % of the initial compound) of the relevant weight decreases or increases due to cleavage or uptake of NH₃ ligands are marked with a frame.

### Example 1: [Cu(NH₃)₄]SO₄

FIG. 1 shows the TGA curve of tetraammine copper sulfate produced in Synthesis Example 1. Table 1 below lists the temperatures of the starting points of the weight decreases during heating and the weight increases during cooling.

TABLE 1

| | NH₃ cleaving | NH₃ uptake |
|---|---|---|
| Step 1, 1 NH₃ ligand | 79° C. | 66° C. |
| Step 2, 2 NH₃ ligands | 168° C. | 138° C. |
| Step 3, 1 NH₃ ligand | 307° C. | 248° C. |

It can be seen that in the case of [Cu(NH₃)₄]SO₄, the four NH₃ ligands are cleaved off in three steps during heating, where first one ligand is cleaved off, then two ligands are cleaved off together, and finally one ligand is cleaved off again. During the subsequent cooling by introducing ammonia-containing carrier gas, the original tetraammine complex is also restored in steps, the re-attachment of the four NH₃ ligands ocurring according to the same (reverse) scheme 1-2-1.

These results clearly show that both the heat storage and the subsequent heat release using this ammine complex as heat carrier can be carried out in two or three steps, wherein the cleavage and the re-uptake of the NH₃ ligands can be carried out according to any of the schemes 1-2-1, 1-3, 3-1, 1-2 or 2-1, depending on the temperatures to which the ammine complex or the ligand-free transition metal salt is exposed or how quickly the heating or cooling takes place. The temperature differences between the individual stages in both processes, i.e. cleavage and uptake of NH₃ ligands, amount to several dozen Kelvin each, so that a temperature in between can be selected easily.

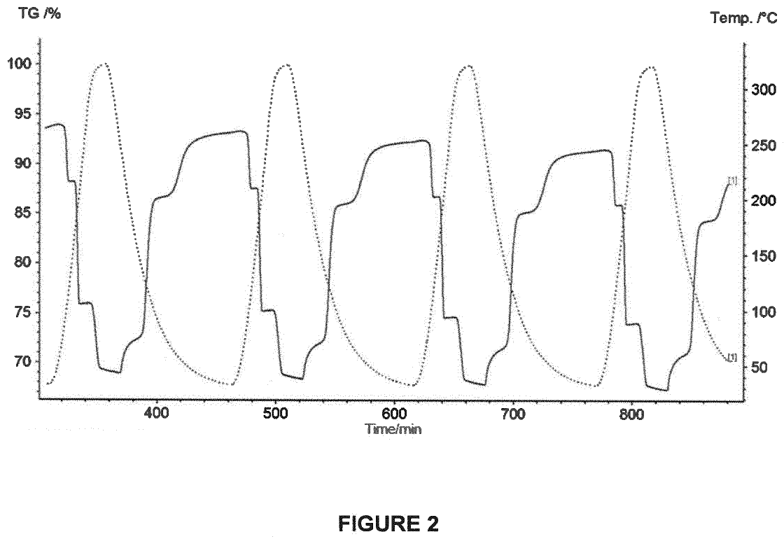

FIG. 2 shows a corresponding TGA curve for the cycling of [Cu(NH₃)₄]SO₄ in three steps, for which both the heat storage and the heat release were carried out according to the scheme 1-2-1. While in the test shown in FIG. 1 the process of heat storage and release lasted about 600 min (i.e. 10 h), in the test shown in FIG. 2 the duration of one cycle was only about 150 min (i.e. 2.5 h), although in both cases the same maximum temperature of about 320° C. was reached.

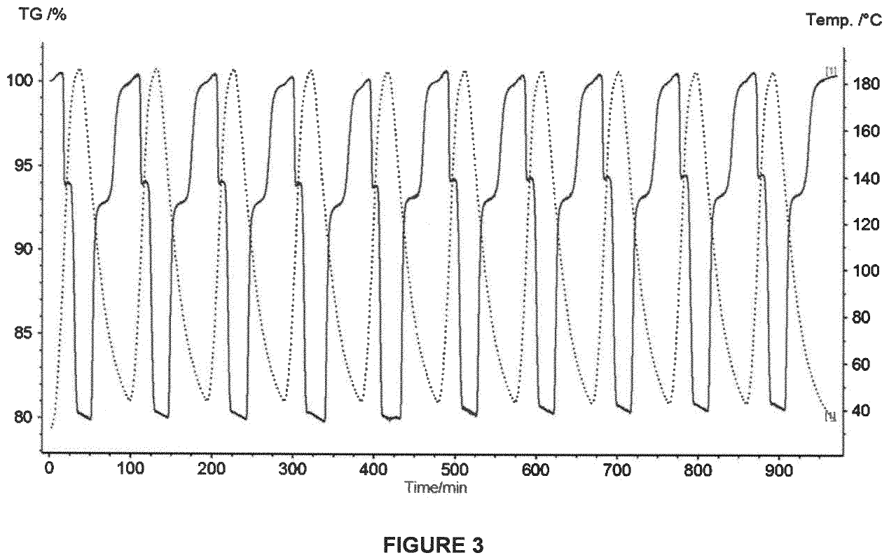

FIG. 3, on the other hand, shows the TGA curve of an analogous cycle, but with only two steps using the scheme 1-2 for heat storage and the reverse scheme 2-1 for heat release, wherein the heating was performed to a maximum temperature of just over 180° C., so that only three NH₃ ligands were repeatedly cleaved off and taken up again and the fourth remained coordinated at the Cu atom, as can be seen from the temperature data in Table 1. Accordingly, the duration of one cycle in this experiment was only about 95 minutes.

It can be seen that in the cycles of heat storage and release, combinations of two different schemes for the two partial steps are also possible, which increases the flexibility in the choice of temperature enormously compared to the state of the art.

### Example 2: [Ni(NH₃)₄]SO₄

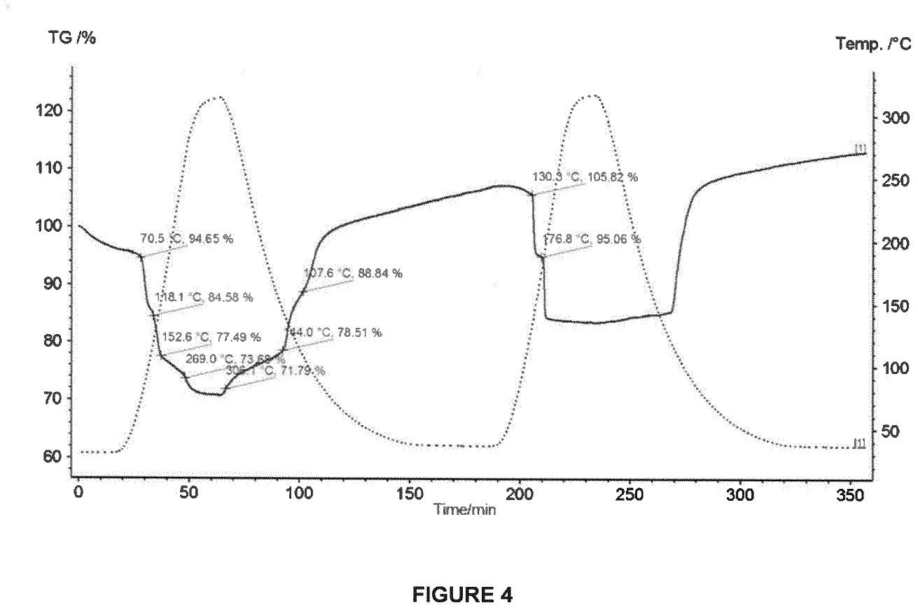

FIG. 4 shows the TGA curve of the tetraammine nickel sulfate produced in Synthesis Example 2. Table 2 below again lists the temperatures at the starting points of the weight decreases and increases.

TABLE 2

| | NH₃ cleaving | NH₃ uptake |
|---|---|---|
| Step 1, 2 NH₃ ligands | 71° C. | 107° C. |
| Step 2, 1 NH₃ ligands | 118° C. | 144° C. |
| Step 3, 1 NH₃ ligand | 153° C. | 306° C. |

Here it can be seen that the cascading process is not stable across cycles, i.e. in the first cycle, a cleaving pattern of 2-1-1 can be seen, while in the second cycle, only a ligand cleavage of 2-2 will occur. While a cascading uptake of the NH₃ ligands will occur during the first cooling in NH₃, this process will only occur continuously during the second cooling.

### Example 3: [Co(NH₃)₄ ]SO₄

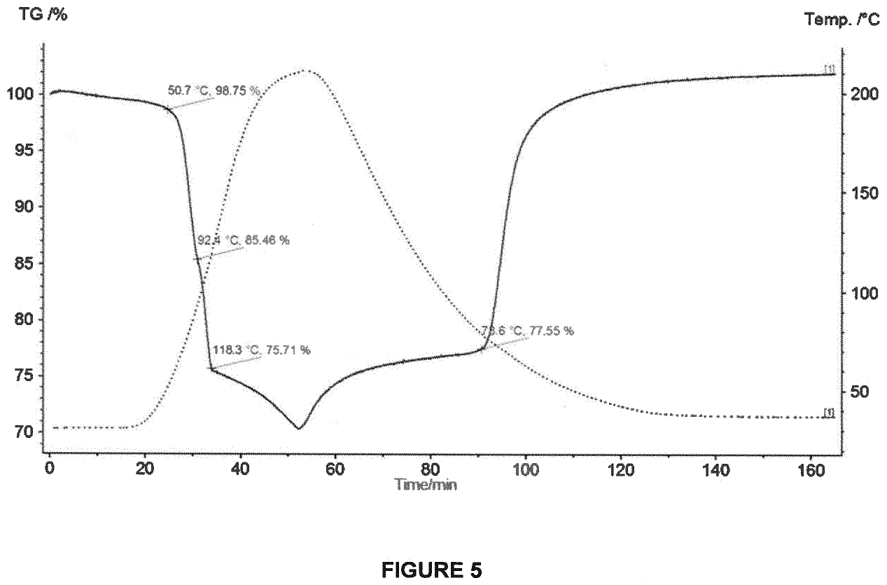

FIG. 5 shows the TGA curve of the tetraammine cobalt sulfate produced in Synthesis Example 3, and the following table 3 lists the relevant temperatures.

TABLE 3

| | NH₃ cleaving | NH₃ uptake |
|---|---|---|
| Step 1, 2 NH₃ ligands | 51° C. | — |
| Step 2, 2 NH₃ ligands | 92° C. | 79° C. |

It can be seen that the four NH₃ ligands from the cobalt complex are cleaved off in two steps from two ligands each, the temperature difference amounting to around 40° C., such that a maximal temperature in between may be easily selected so that only two out of four ligands will be cleaved off, if desired, if there is not enough storable heat available. The ligand re-uptake however will only take place in one single step, starting from approximately 79° C., such that by using this transition metal salt-ammine complex only the stepped variant of heat storage used in this experiment will be available.

### Example 4: [Zn(NH₃)₄]SO₄

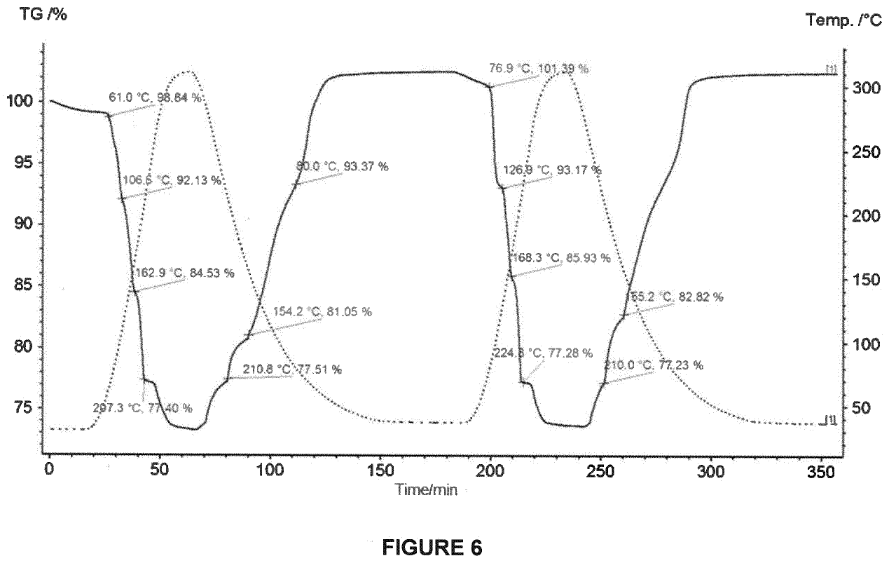

FIG. 6 shows the TGA curve of the tetraammine zinc sulfate produced in Synthesis Example 4, and the following table 4 lists the relevant temperatures.

TABLE 4

| | NH₃ cleaving | NH₃ uptake |
|---|---|---|
| Step 1, 1 NH₃ ligand | 61/77° C. | 80° C. |
| Step 2, 1 NH₃ ligand | 107/127° C. | 155° C. |
| Step 3, 1 NH₃ ligand | 163/168° C. | 210° C. |
| Step 4, 1 NH₃ ligand | 207/225° C. | approx. 250° C. |

It can be seen that in the heat storage process, the four ligands from [Zn(NH₃)₄]SO₄ are cleavable in four steps, especially since the temperature differences between these steps each amount to around 40° C. and 60° C., respectively. The ligand re-uptake occurs in four steps, the first NH₃ uptake starting at approximately 250° C.

### Example 5: [Cu(NH₃)₅ ]Cl₂

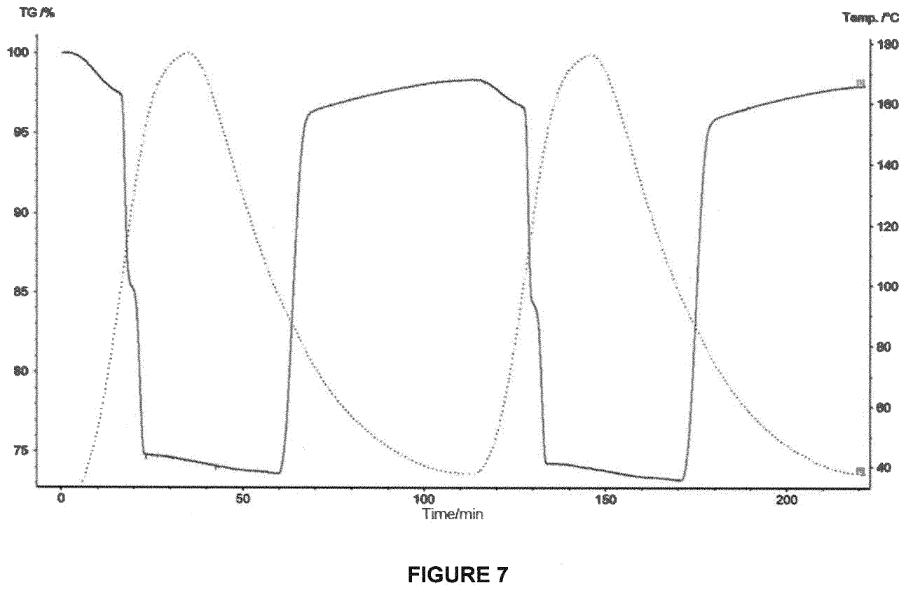

FIG. 7 shows the TGA curve of the pentammine copper chloride produced in synthesis example 5, and the following table 5 lists the relevant temperatures.

TABLE 5

| | NH₃ cleaving | NH₃ uptake |
|---|---|---|
| Step 1, 3 NH₃ ligands | 98° C. | 94° C. |
| Step 2, 2 NH₃ ligands | 128° C. | |

Here it can be seen that the cleavage of the 5 NH₃ ligands occurs in two steps according to the scheme 3-2, while the NH₃ uptake occurs continuously and thus in a non-cascading manner.

### Examples 6 to 10, Comparitive Example 1—Tests with Carrier Materials

In order to investigate whether heat storage or release can also be carried out in a cascading manner using ammine complexes bound to carrier materials, the ammine complex that performed best in the above examples, i.e. tetraammine copper sulfate [Cu(NH₃)₄]SO₄, was tested supported on different carrier materials.

For this purpose, 50 g of the respective carrier material were immersed in a saturated CuSO₄ solution for varying periods of time and thus impregnated. The respective product was then separated, rinsed with 200 ml deionized water and dried at 60° C. for 12 h and then at 350° C. for 6 h. The respective CuSO₄ contents were determined by X-ray fluorescence analysis.

Subsequently, the carriers impregnated with CuSO₄ were gassed with NH₃ in the laboratory fluidized bed reactor to produce the tetraammine copper sulfate complexes, which were subsequently subjected to similar heating/cooling cycles and treatments as described above with simultaneous TGA analysis. In addition, the amount of thermal energy storable in the materials was determined by DSC analysis.

### Comparative Example 1: [Cu(NH₃)₄]SO₄ on Zeolite

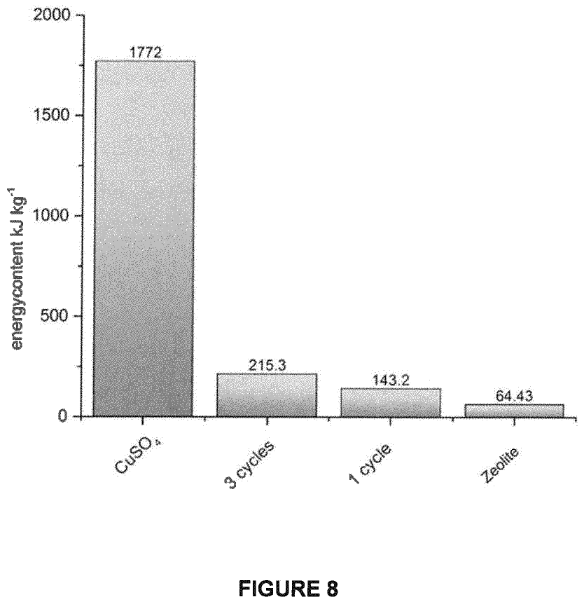

In analogy to their earlier experiments described in the patent application cited at the beginning, the inventors first tested zeolite as a carrier material. For this purpose, two different loads of zeolite with copper sulfate were prepared, for which the carrier was subjected to one impregnation cycle or three impregnation cycles in CuSO₄ solution, respectively, and the impregnated carriers were then directly reacted with NH₃ in the DSC TGA instrument to form the tetraammine complex in order to measure the heat flows. The heat quantities that could be stored in the impregnated substrates were calculated to be 143.2 and 215.3 kJ/kg, respectively. For comparison: In pure [Cu(NH₃)₄]SO₄, 1772 kJ/kg are storable, and in pure zeolite 64.43 kJ/kg are storable, as shown graphically in FIG. 8.

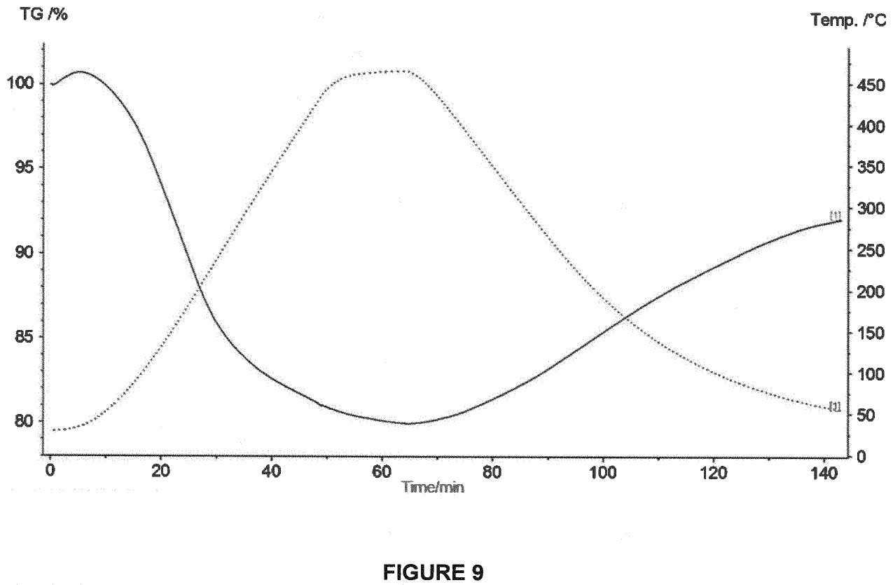

FIG. 9 shows the TGA curve of the material with three impregnation cycles, where it can be seen that neither the heat storage medium nor the heat release could be cascaded when using this material as a heat storage medium, since differing temperature levels of the individual reactions of the ligands could not be determined.

### Example 6: [Cu(NH₃)₄]SO₄Activated Charcoal

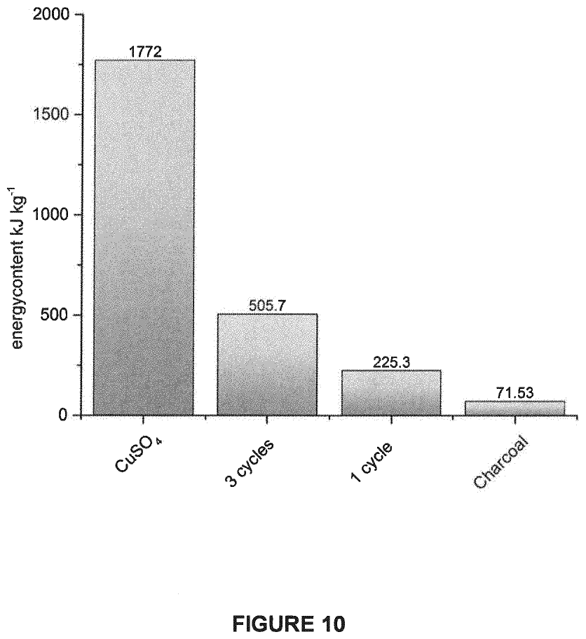

In an analogous manner to the above experiment using zeolite, activated charcoal (grain size 1-5 mm, untreated) was impregnated with CuSO₄ solution in one or three cycles, respectively, and reacted in the DSC TGA instrument with NH₃ to give the tetraammine complex. This resulted in storable heat quantities of 225.3 or 505.7 kJ/kg, respectively, the value for activated charcoal itself being 71.53 kJ/kg, as shown graphically in FIG. 10.

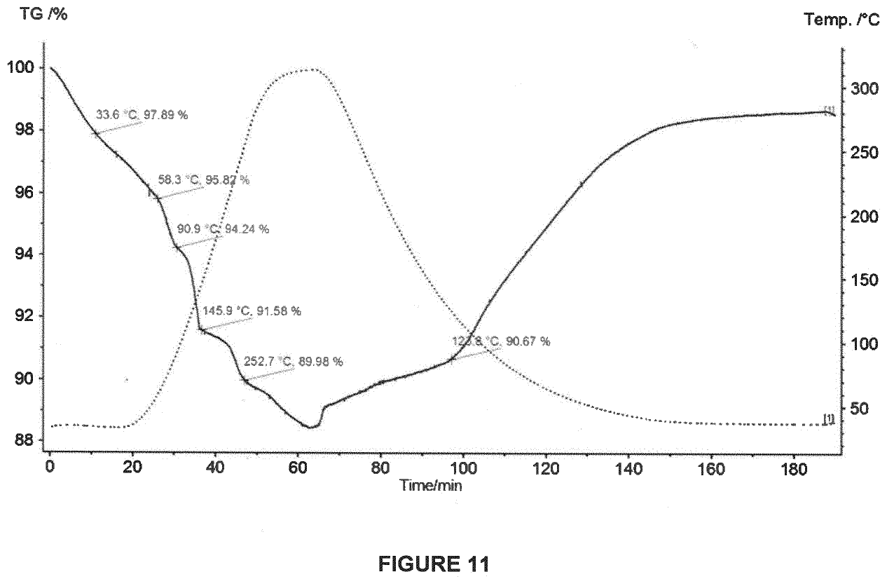

FIG. 11 shows the TGA curve of the material with three impregnation cycles, where it is noticeable that in this case the four NH₃ ligands of the ammine complex were cleaved off individually, i.e. in four steps, whereas with pure [Cu(NH₃)₄]SO₄ in Example 1 there were only three steps. However, the four ligands were not taken up in a cascaded manner during cooling in ammonia, whereas this had also occurred in three steps for the complex without carrier material.

Due to the sufficiently large differences between the four stages of ligand cleavage, this material can be used in practice for cascaded heat storage. However, due to the lacking possibility of also carrying out the heat release in a cascaded way, this material is not preferred according to the present invention.

### Example 7: [Cu(NH₃)₄]SO₄

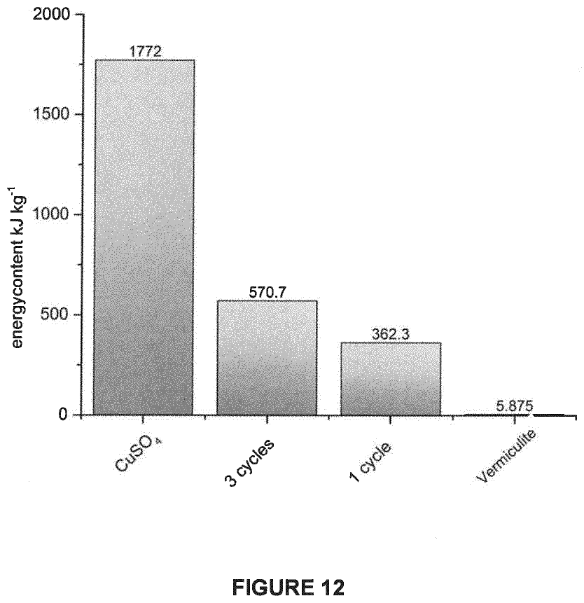

In an analogous manner to the above tests, vermiculite (grain size 1-3 mm) was loaded with copper sulfate in one or three impregnation cycles, respectively, which was reacted with NH₃ to form the tetraammine complex. This resulted in quite acceptable values for the storable heat quantities of 362.3 and 570.7 kJ/kg, respectively, the value for vermiculite itself only being 5.9 kJ/kg, as shown graphically in FIG. 12.

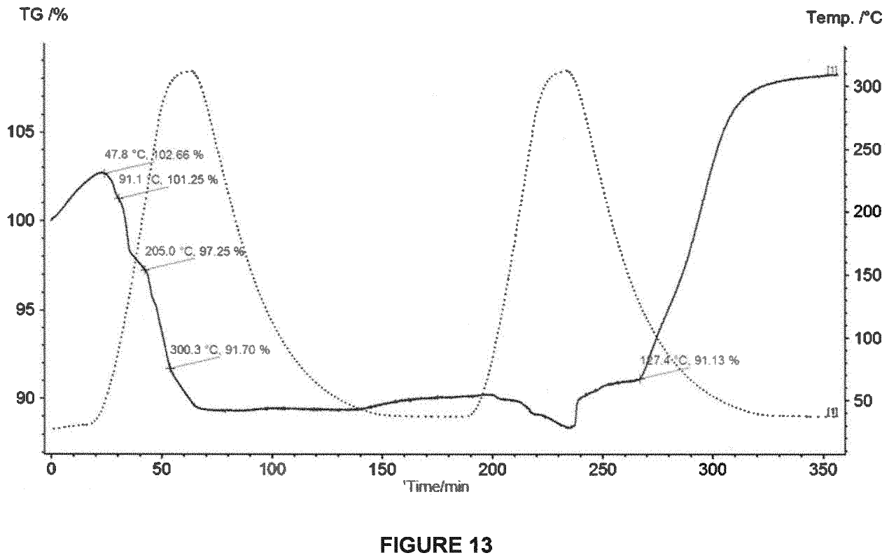

FIG. 13 again shows the TGA curve of the material impregnated within three cycles, in this case the ammonia supply being only started after heating twice to maximum temperature. Even apart from this, the overall result differs from the previous examples: on vermiculite, the four NH₃ ligands are apparently cleaved off in two steps of two ligands each, while the re-attachment during cooling again occurred in a single step.

Since the temperature difference between the two stages was around 100° C., but the heat release could not be carried out in a cascaded manner here either, this material can also be used in practice, but is not preferred according to the present invention.

### Example 8: [Cu(NH₃)₄]SO₄ on Celite

Celite was loaded with copper sulfate at a weight ratio between CuSO₄ and carrier of 10:1, which was again reacted in NH₃ to form the tetrammine complex, resulting in an excellent calculated heat storage capacity of 1136 kJ/kg.

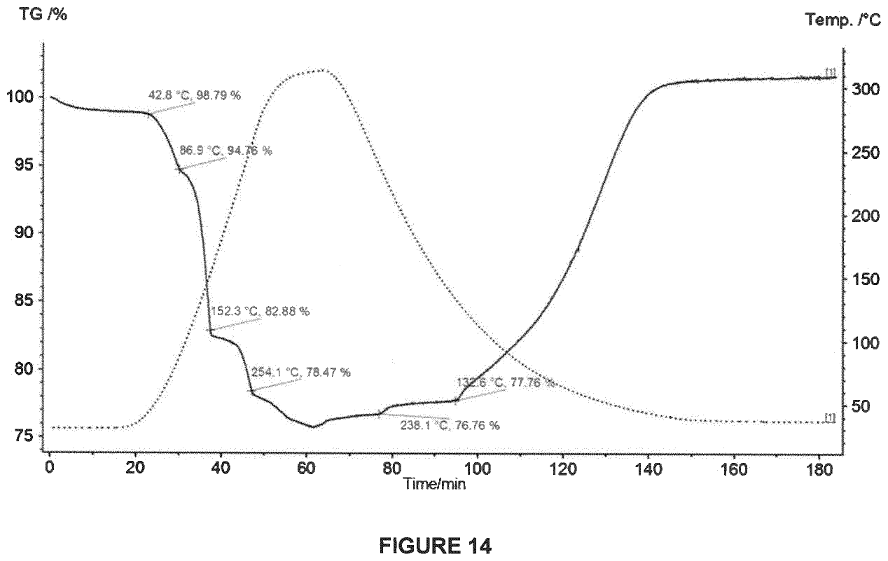

FIG. 14 shows the TGA curve of this material, and it was shown here that the ligand cleavage of the ammine complex on the carrier followed the same scheme as for the pure ammine complex in Example 1, which was 1:2:1. However, the heat release upon renewed ligand incorporation was not cascaded with this material, either.

Due to the relatively high temperature differences between the stages and the relatively high heat storage capacity, this material is quite well suited for practical application and therefore preferred according to the present invention.

### Example 9: [Cu(NH₃)₄]SO₄ on Silica

In an analogous manner to the above experiment with Celite, silica (particle size 60 μm) was also loaded with copper sulfate at a weight ratio of 10:1, which was reacted in NH₃ to form the tetrammine complex, resulting in an even better calculated heat storage capacity of 1263 kJ/kg.

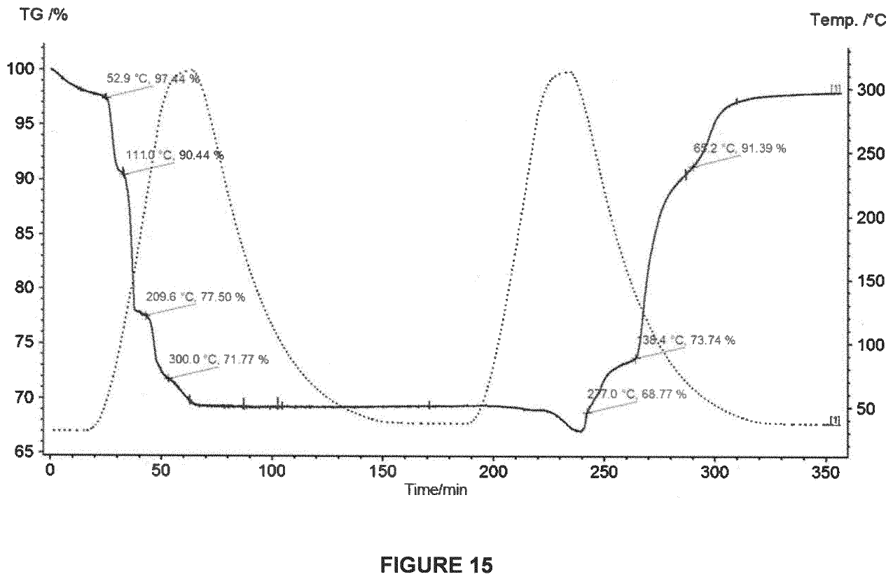

FIG. 15 shows the TGA curve, and it is noticeable that in this case both processes, i.e. heat storage and release, can be cascaded according to the same 1-2-1 scheme as the pure ammine complex. Due to the very large temperature differences between the individual stages in both processes, silica is a particularly preferred carrier material for the present invention.

### Example 10: [Cu(NH₃)₄]SO₄ on Sepiolite

In an analogous manner to example 9, sepiolite was loaded with copper sulfate at a weight ratio of 10:1, which was reacted in NH₃ to form the tetrammine complex, resulting in an equally excellent heat storage capacity of 1227 kJ/kg.

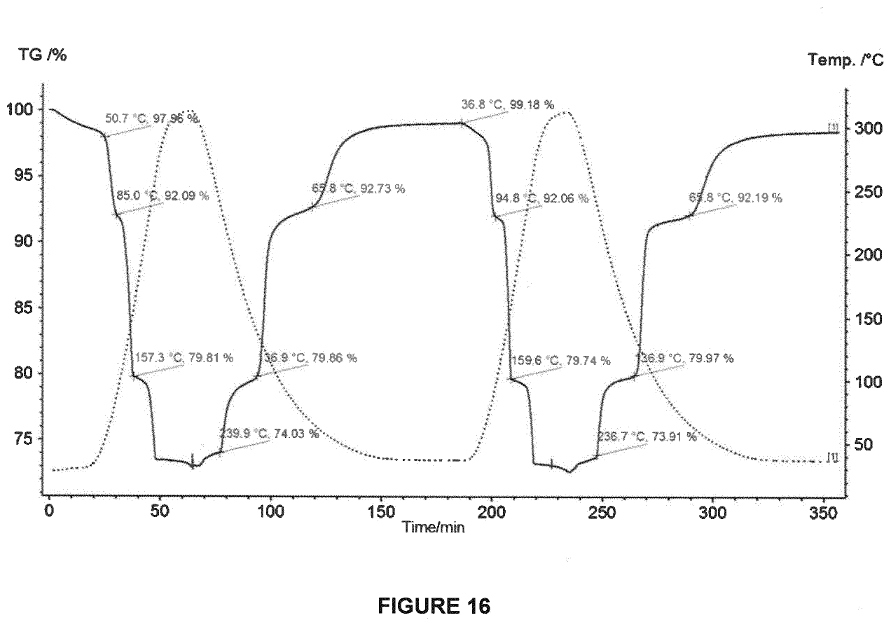

The TGA curve in FIG. 16, illustrating two successive cycles of heat storage and release, shows that this material also follows the same scheme 1-2-1 in both processes and is excellently suited for practical application in view of the equally large temperature differences.

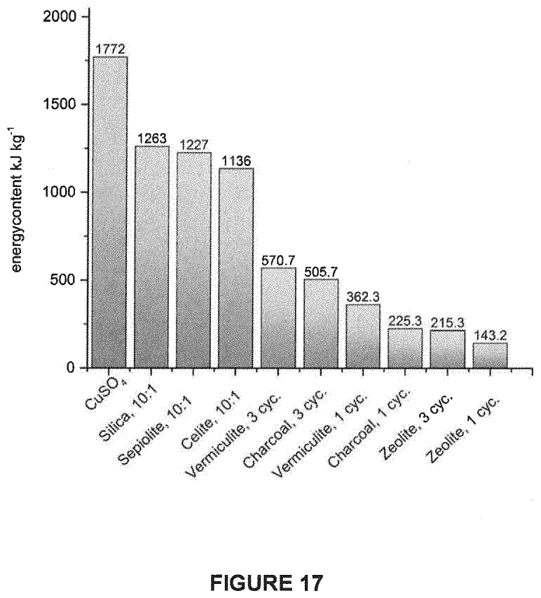

FIG. 17 shows the tetraammine copper sulfate complexes bound to the various carrier materials as produced in Examples 6 to 10 and in the comparative example, arranged according to their heat storage capacity. It can be seen that the combinations with silica, sepiolite and Celite are significantly more potent than those with zeolite, activated charcoal and vermiculite.

Due to the lower costs compared to Celite and silica, however, sepiolite is currently the carrier material of choice for practicing the method according to the invention.

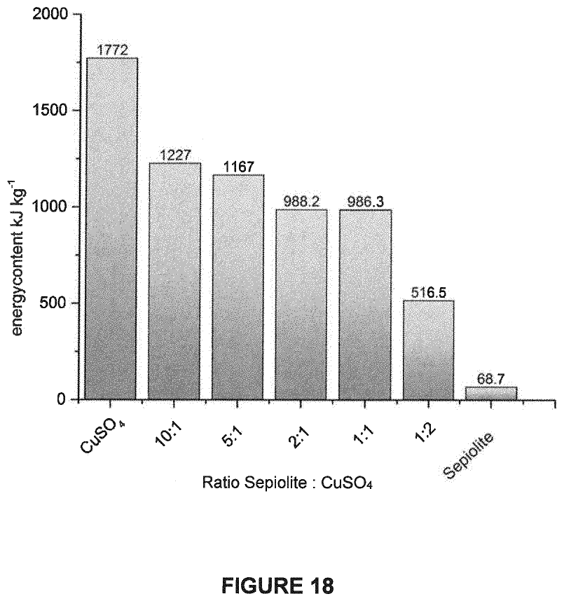

Consequently, further experiments were conducted with sepiolite as a carrier, in which the ratios 5:1, 2:1, 1:1 and 1:2 were investigated in addition to the already tested ratio of 10:1 between ammine complex and carrier material. FIG. 18 shows the corresponding heat storage capacities. It can be seen that even at the lowest content of copper complex, i.e. at 2 parts by weight of carrier per 1 part by weight of ammine complex, the heat storage capacity is already one order of magnitude higher than that of pure sepiolite and is doubled at the transition from 1:2 to 1:1. Surprisingly, however, the amount of heat that can be stored practically does not change at all when the amount of ammine complex is doubled to the ratio 2:1, after which the increase to 5:1 only brings about a 20% improvement in heat storage capacity and doubling the ratio to 10:1 again hardly shows any improvement.

Thus, it may be deducted that, with regard to heat storage capacity, the preferred ratio between copper sulfate and sepiolite should be at least 3:1, even more preferably between 4:1 and 6:1, and especially about 5:1. With regard to the costs of the heat storage medium, however, a ratio of 1:1 can be considered sufficient in practice in many cases.

1. A method of thermo-chemical energy storage by carrying out reversible chemical reactions for storing heat energy in the form of chemical energy in one or more ammine complexes of transition metal salts of the formula [Me(NH₃)ₙ]X, wherein Me is at least one transition metal ion and X is one or more counterions in an amount sufficient for charge equalization of the complex, by using the following chemical equilibrium:
[Me(NH₃)ₙ]X+ΔH_{R} [symbol] _{MeX+}nNH₃,
characterized in that said heat storage is performed by endothermic cleavage of the NH₃ ligands from the ammine complex and/or that the heat release is performed by exothermic loading of the transition metal salt with the NH₃ ligands in at least two steps at different temperatures.

2. The method according to claim 1, characterized in that a salt of Cu, Ni, Co or Zn is used as the transition metal salt.

3. The method according to claim 1 characterized in that a sulfate or chloride of the transition metal is used as the transition metal salt.

4. The method according to claim 3, characterized in that CuSO₄ is used as the transition metal salt.

5. The method according to claim 1 characterized in that the transition metal salt is utilized supported on a carrier material which is inert to the reaction.

6. The method according to claim 5, characterized in that silica, sepiolite, Celite, vermiculite or activated charcoal are used as the carrier material.

7. The method according to claim 5, characterized in that the transition metal salt supported on the carrier material is used at a weight ratio between salt and carrier material of at least 1:1.

8. The method according to claim 7, characterized in that the transition metal salt supported on the carrier material is used at a weight ratio between salt and carrier material of between 4:1 and 6:1.

9. The method according to claim 2, characterized in that a sulfate or chloride of the transition metal is used as the transition metal salt.

10. The method according to claim 9, characterized in that silica, sepiolite, Celite, vermiculite or activated charcoal are used as the carrier material.

11. The method according to claim 2, characterized in that the transition metal salt is utilized supported on a carrier material which is inert to the reaction.

12. The method according to claim 3, characterized in that the transition metal salt is utilized supported on a carrier material which is inert to the reaction.

13. The method according to claim 4, characterized in that the transition metal salt is utilized supported on a carrier material which is inert to the reaction.

14. The method according to claim 10, characterized in that the transition metal salt is utilized supported on a carrier material which is inert to the reaction.

15. The method according to claim 6, characterized in that the transition metal salt supported on the carrier material is used at a weight ratio between salt and carrier material of at least 1:1.

16. The method according to claim 11, characterized in that the transition metal salt supported on the carrier material is used at a weight ratio between salt and carrier material of at least 1:1.

17. The method according to claim 12, characterized in that the transition metal salt supported on the carrier material is used at a weight ratio between salt and carrier material of at least 1:1.

18. The method according to claim 13, characterized in that the transition metal salt supported on the carrier material is used at a weight ratio between salt and carrier material of at least 1:1.

19. The method according to claim 15, characterized in that the transition metal salt supported on the carrier material is used at a weight ratio between salt and carrier material of between 4:1 and 6:1.
